(19) United States
(12) Patent Application Publication
(10) Pub. No.: US 2003/0124354 A1
(43) Pub. Date: Jul. 3, 2003

(54) Colored high-protective multi-layered polymer coated articles and method of making same

(76) Inventor: Maris Vistins, Alpharetta, GA (US)

Correspondence Address: KIMBERLY-CLARK WORLDWIDE, INC., 401 NORTH LAKE STREET, NEENAH, WI, 54956

(21) Appl. No.: 10/034,042

(22) Filed: Dec. 27, 2001

(51) Int. Cl. B32B 9/04; B29C 41/14

(52) U.S. Cl. 428/411.1; 264/304; 264/306; 264/308

(57) ABSTRACT

A method of making a colored, multi-layered polymer coated film-based article includes the steps of providing a former in the shape of an article; dipping the former in a first polymeric solution in order to coat the former with a polymeric film of the first polymeric solution; withdrawing the former from the first polymeric solution and allowing the coated former to dry; dipping the former in a second polymeric solution in order to again coat the previously coated former, wherein the second polymeric solution produces a coating of observable contrast to the first coating; withdrawing the former from the second polymeric solution and allowing the second coating to dry, thereby forming an article on the former; and stripping the article from the former. A colored polymer coated film-based article includes a first layer of a polymeric film material; a second layer of polymeric film material formed on top of the first layer, the second layer in visual contrast from said first layer.

### FIELD OF THE INVENTION

The present invention relates to colored multi-layered polymer coated articles. More particularly, the present invention relates to colored multi-layered polymer coated gloves and other film-based articles.

### BACKGROUND OF THE INVENTION

Highly elastic protective articles such as surgical and examination gloves, condoms and catheter balloons, have been traditionally made of natural latex in order to utilize its combination of good elasticity and strength. However, since some persons have exhibited allergic responses to natural latex, alternative technology has been pursued which does not produce such reactions. In this regard, synthetic polymeric materials have been used as base materials for film-based elastomeric articles, which have demonstrably reduced the concern over allergic responses. For instance, synthetic materials such as styrene-ethylene butylene-styrene (S-EB-S) block copolymer materials have been used as base material. U.S. Pat. Nos. 5,112,900 and 5,407,715 describe the use of such S-EB-S block copolymers in gloves, such as Kraton brand polymers. While such glove constructions have proven highly effective from a performance and wearability perspective, the manufacturing costs of such glove base materials and gloves produced therefrom can be high. Therefore, less costly synthetic base material alternatives have also been considered. For instance, U.S. Pat. No. 5,881,386 describes a flexible polyvinyl chloride article and method of making such article. Such patent also describes a single layered coating of polyurethane on a glove. U.S. Pat. No. 3,059,241 describes a dipped plastic glove containing a vinyl chloride-vinyl acetate copolymer, which can be transparent, translucent or opaque, or in the alternative colored.

However, even with the advantages of such polymeric alternatives, gloves made from such materials have often proven difficult to don. In particular, the elastomeric action of the material of construction, its friction with the skin of the user, and the perspiration on the body of the user all act in concert to make it difficult to slip such an article on. To overcome this problem, it has been conventional practice to apply a powdered lubricant to the surface that is to contact the body of the user, such as the inside of the glove. As an example, U S Pharmacopeia absorbable corn starch is a common powder applied to the inside surface of elastomeric gloves during manufacture, in order to permit them to be more readily slipped onto the hand of a user.

While the use of a powdered lubricant on the elastomer is operable, it has drawbacks in specific situations, such as in the case of surgical gloves, medical examination or gloves for use under cleanroom conditions. If some of the powder escapes from the inside of the gloves into either a medical environment, or operating room, the powder may enter the surgical wound. In the case of the surgical environment, the powder may also carry infectious agents, or the patient may be allergic to the powder. In the case of a cleanroom manufacturing environment, during a manufacturing step the powder may contaminate the product being constructed, causing further complications.

Currently, in order to overcome the issues associated with powdered lubricants, coatings are used to render gloves powder free and to improve donning. For instance, an inner layer may be included on the glove during manufacture, which includes a hydrophilic polymer. Alternatively, a slip coating may be applied to the inner surface of the glove, or the glove may be provided with lubricating particles on its inner surface to enhance donning. In either case, the user of such gloves is often unfamiliar with the level and sophistication of layering in such gloves, and often does not have a sense of the level of barrier protection afforded by the glove.

With the current concern on reducing the spread of viral infections or other blood-born pathogens, there has been much focus in the glove manufacturing field on developing gloves with sufficient barrier protection, as well as gloves which provide a signal to their user that the barrier has been compromised in some way. In this regard, medical practitioners have often double-gloved prior to entering a surgical environment. That is, medical staff have participated in the practice of wearing two gloves to protect against inadvertent puncture of one of the glove barriers. Furthermore, gloves have been developed which include multiple latex layers surrounding an inner layer, which contains a chemical signal of sorts. The chemical signal typically changes color upon breach of a glove barrier layer. See for instance, U.S. Pat. No. 6,175,962B1, and WO9402080, as well as U.S. Pat. Nos. 6,145,130A, 5,911,848, 5,679,399 and 5,619,752. See also U.S. Pat. Nos. 4,935,308, 4,992,335 for further examples in this regard. Multiple layered and colored gloves have also been produced by welding together four plastic layers. However, even given the presence of such product descriptions in the literature, there is still a need for manufacturing processes which allow for the production of affordable elastomeric articles for indicating the levels of protection available, thereby instilling a level of knowledge as to multiple layer protection in a user. There is a further need for such gloves to be powder-free, thereby allowing for easy donning. Furthermore, there is a need for glove manufacturing processes which allow for control of production setup, environment and manufacturing procedures, and gloves which include negligible particle count for the scientific market. Furthermore, there is also a need for additional protective powderfree gloves in various glove markets.

### SUMMARY OF THE INVENTION

The aforesaid needs are fulfilled and the problems experienced by those skilled in the art overcome by a method of making a colored, multi-layered polymer coated film-based article including the steps of providing a former in the shape of an article; dipping the former in a first polymeric solution or coagulant in order to coat the former with a polymeric film of the first polymeric solution; withdrawing the former from the first polymeric solution and allowing the coated former to dry, fuse, or cure, if necessary; dipping the former in a second polymeric solution in order to again coat the previously coated former, wherein the second polymeric solution produces a coating of observable contrast to the first coating; withdrawing the former from the second polymeric solution and allowing the second coating to dry, thereby forming an article on the former; and stripping the article from the former.

A colored polymer coated film-based article includes a first layer of a polymeric film material; a second layer of polymeric film material formed on top of the first layer, the second layer in visual contrast from the first layer.

A colored polymer coated film-based article includes a first layer of a polymeric film material; wherein the first polymeric film material includes flexible polyvinylchloride, a second layer of polymeric film material formed on top of the first layer, wherein the second layer of polymeric film material includes a polyurethane, the second layer in visual contrast from the first layer.

### BRIEF DESCRIPTION OF THE DRAWINGS

FIG. 1 illustrates a flow chart diagram of method steps for producing articles in accordance with the present invention.

FIGS. 2-4A and B illustrate a series of top views of gloves, showing the layers made in accordance with the invention by steps similar to those described in the method steps of FIG. 1.

FIG. 5 illustrates a side view of a glove manufacturing assembly with formers, which may be used in the inventive dipping process illustrated in FIG. 1.

FIG. 6 illustrates a glove on a user's hand, manufactured in accordance with the inventive process of FIG. 1.

FIG. 7 illustrates a condom, manufactured in accordance with the inventive process of FIG. 1.

### DEFINITIONS

As used herein, the term “dry” shall mean the application of heat or air to form an elastomeric film.

As used herein, the term “solution” shall mean a completely formulated compound that can be dipped for film forming.

As used herein, the term “PU” shall mean polyurethane.

As used herein, the term “PVC” shall mean flexible polyvinyl chloride.

As used herein, the term “disposable” shall mean an article that is either meant for a single use, or for limited use, and is to be discarded after use.

As used herein, the terms “former immersion time” or “dwell time” shall be used interchangeably, and shall refer to the length of time the former remains immersed in a coating material or solution.

As used herein, the terms “dip tank”, “dip bath”, or “dip station” shall be used interchangeably, and shall refer to the container or vessel for holding film-forming material, such as latex emulsions, polymer/solvent solutions, or coagulant materials.

As used herein, the term “clear” shall mean easily seen through, substantially transparent or transparent.

As used herein, the term “translucent” shall mean allowing the passage of light, but not allowing objects beyond to be clearly seen, but allowing contrasts to be seen.

As used herein, the term “opaque” shall mean not allowing the passage of light, or objects beyond to be clearly seen.

As used herein, the term “hue” shall mean the attribute of colors that permits them to be classed as red, yellow, green, blue or an intermediate between contiguous pairs of these colors.

As used herein, the term “'saturation” as in color saturation, shall refer to freedom from dilution with white.

As used herein, the term “tint” shall mean any of various lighter or darker shades of a color, a variation of a color produced by adding white to it and characterized by a low saturation with relatively high lightness.

As used herein, the term “donning” shall mean the act of slipping a film-based article onto the object it is intended to cover.

As used herein, the term “value” shall mean the lightness or darkness of a color.

As used herein, the term “contrast”, shall mean differences in appearance that are visually distinct to the naked eye, such as color differences, hue or value differences, tint or color saturation differences, opacity differences, translucence differences, and the differences related to the ability to see through articles. Such a contrast would enable an observer to distinguish either a line of demarcation or a zone of demarcation within a film-based material. For instance, differences between similar colors can amount to a contrast if they demonstrate a ΔE* value greater than 3. In this regard, L*a*b* color value measurements and ΔE* calculations (CIE 1976 Commission Internationale de l'Eclairage) may be made using an X-Rite 938 Spectrodensitometer D65/10° using CMY filters, in accordance with the operator's manual. The X-Rite Spectrodensitometer may be obtained from the X-Rite Corporation of Grandville, Mich. Average optical densities are generally taken as the sum of the average of three measurements using each filter. Delta E* is calculated in accordance with the following equation:

ΔE*=SQRT[(L*standard−L*sample)²+(a*standard−a*sample)²+(b*standard−b*sample)²]

The higher the ΔE*, the greater the change in color intensity. Testing may be conducted in accordance with ASTM DM 224-93 and ASTM E308-. Where values for ΔE* are less than 3.0 for a substrate with a matte finish, it is generally accepted that such color change/difference cannot be observed with the human eye. A detailed description of spectrodensitometer testing is available in Color Technology in the Textile Industry, 2^{nd} Edition, Published 1997 by AATCC (American Association of Textile Chemists & Colorists).

As used herein, the term “colored” shall mean containing a colorant.

As used herein, the term “cuff” shall refer to an area on a glove between the wrist area and the opening of the glove, where a glove is typically beaded.

As used herein, the term “line of demarcation” shall mean a line of separation between areas within, or on the surface of a film-based article, that appear visually distinguishable.

As used herein, the term “zone of demarcation” shall mean a zone or region of separation between areas within, or on the surface of a film-based article, that appear visually distinguishable.

### DETAILED DESCRIPTION OF THE INVENTION

The present invention is directed to disposable colored multilayered protective articles, such as gloves, condoms and catheter balloons, which include at least two layers in the composite structure. Alternatively, such articles include at least three or more layers in the composite structure. Such articles may be constructed by methods including sealing extruded films, or dipping processes.

For the purposes of the description that follows, the manufacturing process described will be that of a “dipping” arrangement, that is one in which the article to be manufactured is produced by dipping an article-shaped former into a series of dip tanks or baths. Such processes are described for example in U.S. Pat. Nos. 5,112,900 and 5,407,715 to Buddenhagen et al. which are incorporated by reference herein in their entirety. It should be recognized that for manufacturing methods other than dipping, the articles would by necessity need to be sequentially formed/coated to achieve the desired results. This would result in for example, bonding multiple layers of contrasting film layers to each other.

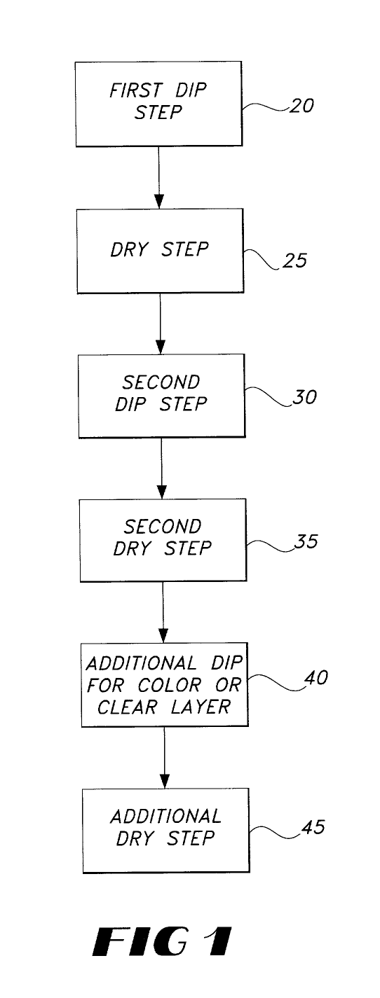

A particularly desirable process for making such a colored, multilayered, film-based article is described in the flow chart of FIG. 1, and includes the following steps. As shown in Step 1 (20) in FIG. 1, a former for making the article is first dipped in a first dip tank containing the desired polymer to create a base polymeric layer on the former. The base polymeric layer will eventually be the exterior article layer upon its removal from the former. In the case of a latex article, the bath contains a water-based latex emulsion. In the case of articles of other polymeric materials, the bath may include a polymer in a solvent system, such as a water or organic solvent system, such as that described in U.S. Pat. Nos. 5,112,900 and 5,407,715. In the case of certain polymeric baths, for certain polymer systems it may be necessary to utilize a coagulant bath or stripping material bath prior to dipping so as to assist the polymer to coagulate on a former used in the dipping process. For example, when manufacturing a glove from latex, a hand-shaped mold or former is first dipped in a coagulant slurry containing calcium nitrate and calcium carbonate. After the slurry has dried on the former, the former is then dipped in the polymeric material bath (which could for example be an elastomeric material such as a natural or synthetic latex). Coagulants typically include a solution of a coagulant salt, such as a metal salt. It should be further noted that when forming a flexible polyvinyl chloride glove, a coagulant composition is not needed.

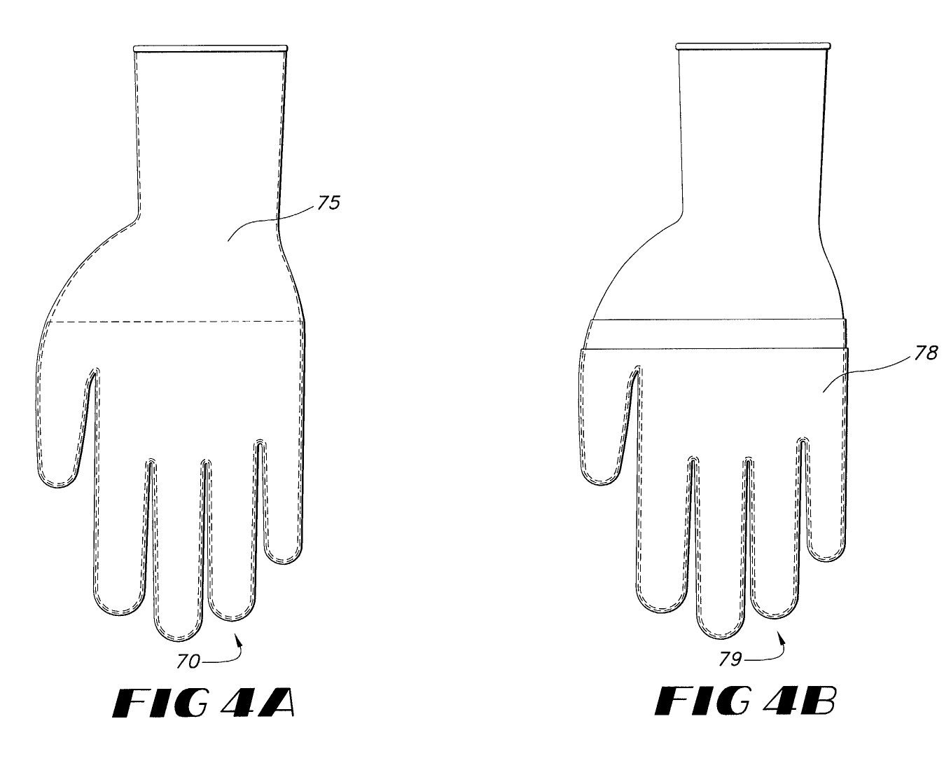

Formers to be used in the process may be made of various materials, however ceramic, porcelain, plastics, metals, or other nonreactive materials known in the art, which can be manipulated into any particular shape are desirable. For instance, in one embodiment, various glove-shaped ceramic formers 80 (See FIG. 5) are initially provided for forming gloves thereon. Although glove-shaped formers are depicted and described below, it should also be understood that formers having any other shape can be used in accordance with the present invention, to form articles having different shapes. Desirably, as shown in FIG. 5, which illustrates a rotating assembly (batch dipping), for glove shaped formers, such formers 80 are rotatably secured to a bar 90, by a rotation device 95. In some embodiments, as indicated by the directional arrows, each former 80 is capable of rotating about a vertical axis Y, that is perpendicular to the floor. In general, the bar 90 can include any number of formers 80 as desired. For example, in the illustrated embodiment, the bar 90 contains four glove-shaped formers 80. Moreover, multiple bars may be utilized in accordance with the present invention. Referring again to FIG. 5, the formers can then be transferred to a first dip tank 100, as part of a dipping station. For example, in one embodiment, the first dip tank 100 contains a coating solution 110. In this embodiment, the dip tank 100 is moveable towards and into contact with the formers 80 such that the formers 80 can become immersed within the coating solution 110 of the dip tank 100 and also be removed therefrom. The speed of the moveable dip tank and the former immersion time can generally be varied to provide different coating thicknesses. It should, however, be understood that the glove formers can alternatively be moveable towards and into contact with the coating solution. Alternatively, formers can be mounted onto a continuously moving chain and dipping is accomplished by directing the chain along a track over a sequential series of dip tanks. Sometimes this method of production is referred to as drag dipping. Dip tanks are known in the art, and typically made from a nonreactive material such as stainless steel. Desirably in one embodiment, such dip tank 100 contains flexible polyvinyl chloride. Other solvent-based systems include toluene solvent systems such as those described in the references to Budenhaggen previously described. Alternatively, such bath can include natural latex, in an amount between about 15 and 35 percent solids contained in a water based-emulsion. Further polymer dips include nitrile, polyurethane, and SEBS type polymers. It should be noted that other components may be included in the emulsion or solution. Such additional components can include plasticizers in an amount of from about 62 to 67 phr in the solvent polymer dipping, particularly present in SEBS-type systems. For instance, mineral oil, such as a refined petroleum paraffinic hydrocarbon oil, can be used as a plasticizer. Still other additives may include curatives, antioxidents, accelerators, fillers and colorants for the latex type polymers.

As previously described, in order to aid in the removal of the dipped article from the former, the former may first be coated with a coagulant. If this is the case, the coagulant is coated on the former via-dipping and allowed to dry prior to dipping the former into the first dip tank for the base polymer (such as latex).

Following the initial dipping into the base polymer for forming the body of the glove (such as for example in a natural or synthetic rubber material), typically having a dwell time of between about 5 seconds and 30 seconds, from the time the glove tips are immersed to the time the tips are removed to achieve the desired thickness in the glove, the former is removed from the first bath and allowed to dry in a dry step 25 (of FIG. 1). For PVC, dwelling is generally not required. Desirably, the thickness of the base polymeric layer is between about 0.05 mm and 0.2 mm in the palm area. Such drying is accomplished in a drying station (not shown) such as in an oven. Drying time and temperature will depend on the thickness of the base polymer layer, base polymer type and oven design. For the fusion of a polyvinyl chloride base polymer coating, such fusion time and temperature is desirably at between about 175° C. to about 225° C., for between about 5 and 10 minutes. Such drying may be accomplished in a variety of ovens. In the case of a dip tank containing a polymer and an organic solvent solution, an enclosure may also be present around the dip tank to remove solvent fumes from the process. It should be appreciated that the dipping in the base polymer tank may involve multiple dips, to achieve the desired thickness.

Again in reference to FIG. 5, in one embodiment, the formers may rotate about a vertical axis, as illustrated in FIG. 5 at “Y”. For example, a rotation device 95 can be activated by a controller (not shown) to actuate the rotation of the former 80. It should be recognized that any rotational direction can be utilized. In general, the rotation of the formers 80 within the drying station facilitates drying, inhibits solvent or compound run-off, which may lead to the appearance of flow marks on the final glove, and therefore assists in the formation of a distributed polymer layer.

It should be noted that the base polymer layer applied in the first step, may or may not be colored. Variations in coloring of layers may be achieved by either the addition of a coloring agent, such as a pigment, dye, or stain in each layer, or by the contrast between one layer and another. For instance, contrast can be created by having a colorant in one layer over one layer absent a colorant, or having two different colored layers overlapping. Should it be desired that the base layer be colored, such color is typically introduced into the glove by pigments which have been mixed into the first dip tank or first polymer compound (base polymer for example) if the first tank is actually a coagulant. Such pigments are desirably present in an amount between about 1% and 5% by weight of the base rubber or other polymer (phr). More desirably, such pigments are present in an amount between about 0% and 1% by weight of the polymer if the base glove is to be translucent. As an example, 1 phr of pigment would be as follows: If one were to have 1000 grams of dip solution or compound, and the solution is only 25% polymer solids, then 1 phr of pigment would be 2.5 grams, or 1 gram of pigment for every 100 grams of polymer. Examples of such pigments include aqueous dispersions of titanium dioxide, phthalocyanine green or blue. These same colors can be dispersed in plasticizers for use in flexible PVC compounds. In an alternative embodiment, the base layer is clear or translucent. Such clear or translucent layer may either be colorless or colored.

Depending on the composition of the first layer (for example, if it is natural latex or nitrile) this layer may be later chlorinated off line, as is well known in the art, in order to reduce the tackiness of the glove and to remove any particles or contamination that may reside on the outside surface of the glove. Materials such as latex are typically tacky to the touch when initially manufactured. The tackiness increases the difficulty in handling the glove or other article during manufacture, packaging and final use. Difficulties encountered include problems in stripping the product from the former, products sticking to one another during packaging, and problems with donning the final glove, as well as associated problems with gripping and feeling through the article when in use. While chlorination is one approach for reducing tackiness and to remove particle contamination, another approach is to cover the tacky layer with another non-tacky polymeric layer, or at least those parts of the article in which the tacky layer will be exposed in the final product.

Following drying of the base polymer layer, the former is then, in a third step 30 (again, as seen in FIG. 1), dipped into a desired polymer coating contained in a second dip tank. Extended dwell time is usually not necessary since the coatings are not formed by coagulation (as in some base polymers), but by wetting or coating the base glove, previously formed on the mold. Thickness is determined by the solids content and dip tank withdrawal speed. In a fourth step, 35 the second layer is allowed to dry under conditions as previously described. In the case of a glove, which is typically formed around a hand-shaped ceramic former, the former may be desirably dipped to the position of the cuff or to any position below the cuff, if complete overlap of layers is not desired. In an alternative embodiment, such second layer is dipped on the former to a position between the wrist and the palm of the glove former, or if the article is another shape, to a position on the article where additional barrier layers are desired or where a user would prefer to see such additional layers. The second layer polymer solution, which is exemplified by a polyurethane coating having between about 1% and 10% solids content, is desirably colored. It should be noted that with higher percentage of solids content, it is more likely that the polymer layer will exhibit flow marks, and an increased drain time will be needed. If such coating layer is colored, it is desirable that such coloring pigment be present in the solution in an amount of between about 0.05 and 0.2% based on the total weight of the coating solution. Desirably, the second layer is present on the article in a thickness of 0.001 mm to about 0.05 mm. Other polymeric materials, which can be used as second layers include Acrylic emulsion and PVC type latex. Such layers may serve as donning layers or another functional role, such as to improve tensile and puncture strength, chemical resistance, resistance to body fluids, reduce pinholes or thin spots that may leak when stressed. For example, such materials may be put on the glove as a coating of between about 0.1 to 0.2 grams/glove, between about 0.2 to 0.5 grams/glove, or between about 0.5 to about 1 grams per glove, depending on the degree of added resistance, strength or thickness desired. The weight of the entire glove is desirably between about 4 and 12 grams, depending on the glove size, and the type of polymer. If the first base polymer layer was colored, it is desirable to make the second coating layer of a color visually distinct from the base polymer color.

For solvent based polymer systems, suitable donning materials include 1,2 polybutadiene (e.g. syndiotactic 1,2 polybutadiene). In one embodiment, for example, the donning layer is formed from a solution that contains from about 2% to about 7% by weight, and particularly from about 3% to about 4% by weight of 1,2 polybutadiene in a solvent (e.g. toluene). For instance, one suitable example of a polybutadiene material that can be dissolved in toluene to form a coating solution is “COMPATA BAG”, which is available from Presto Products and contains syndiotactic 1,2 polybutadiene. The 1,2 polybutadiene can also be formed as an emulsion to be applied as the donning layer. In some embodiments, for example, the emulsion contains from about 5% to about 14% by weight, and particularly about 9% by weight of 1,2 polybutadiene in a surfactant mixture. In one embodiment, the surfactant mixture is sodium dioctyl sulfosuccinate in an amount from about 10 phr to about 100phr, and particularly 40 phr in water. Pre-dispersion can be achieved by dispersing the surfactant mixture and 1,2 polybutadiene solution using a mixer, such as a high shear mixture. In one embodiment, the pre-dispersion is then mixed for about 5 minutes in a rotor/stator (such as a Ross X Series) mixer to generate an average particle size of less than about 1 micrometer. The resulting emulsion can then be filtered and the solvent can be removed by vacuum distillation.

The color contrast between layers may be produced by for example, a colored and colorless layer overlapping/adjacent to one another, such as a yellow layer over a clear layer, two distinctively different colored layers, overlapping/adjacent to one another, such as a red layer over a yellow layer, by two similarly colored layers overlapping and adjacent one another, but of different color hues, tints, saturation or color values, such as a dark red layer overlapping/adjacent a light red layer, by an opaque colored layer and a translucent layer overlapping/adjacent one another, or any combination thereof, such as by an opaque red layer overlapping/adjacent a translucent blue layer, as long as such contrast is sufficient to create a line of demarcation or a zone of demarcation in/on the film-based article. It should be noted that in those embodiments of the invention which do not have complete overlap of layers, a line or zone of demarcation will be quite evident. A line or zone of demarcation will not be evident in those embodiments with complete overlap of layers. In such embodiments, color contrasts will be evident by comparison of the inside and outside surfaces of the articles, as one surface would be visually distinctive from the other.

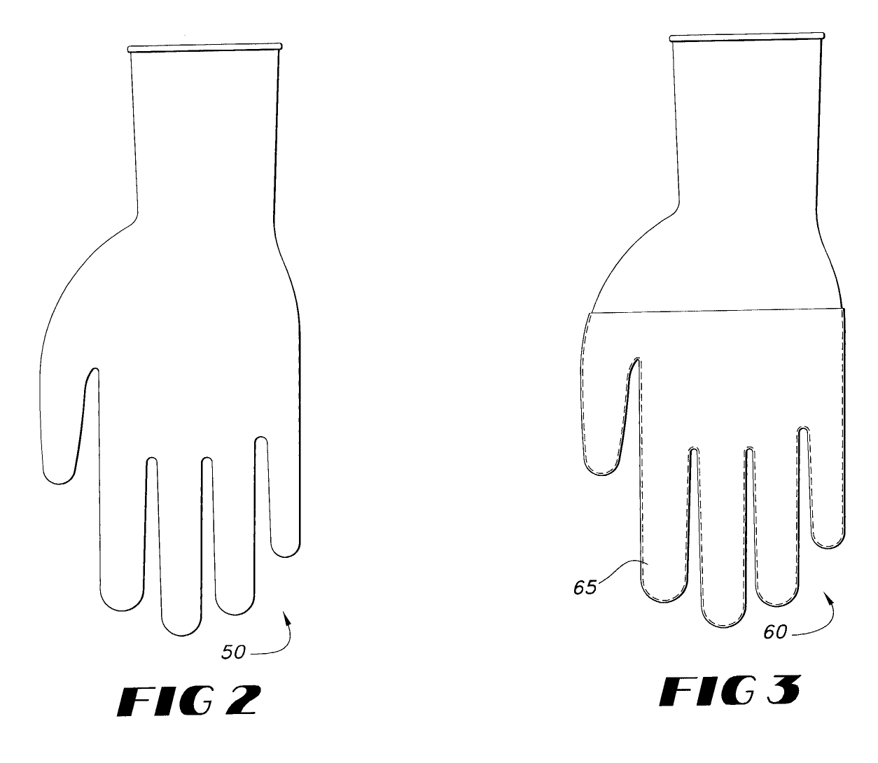

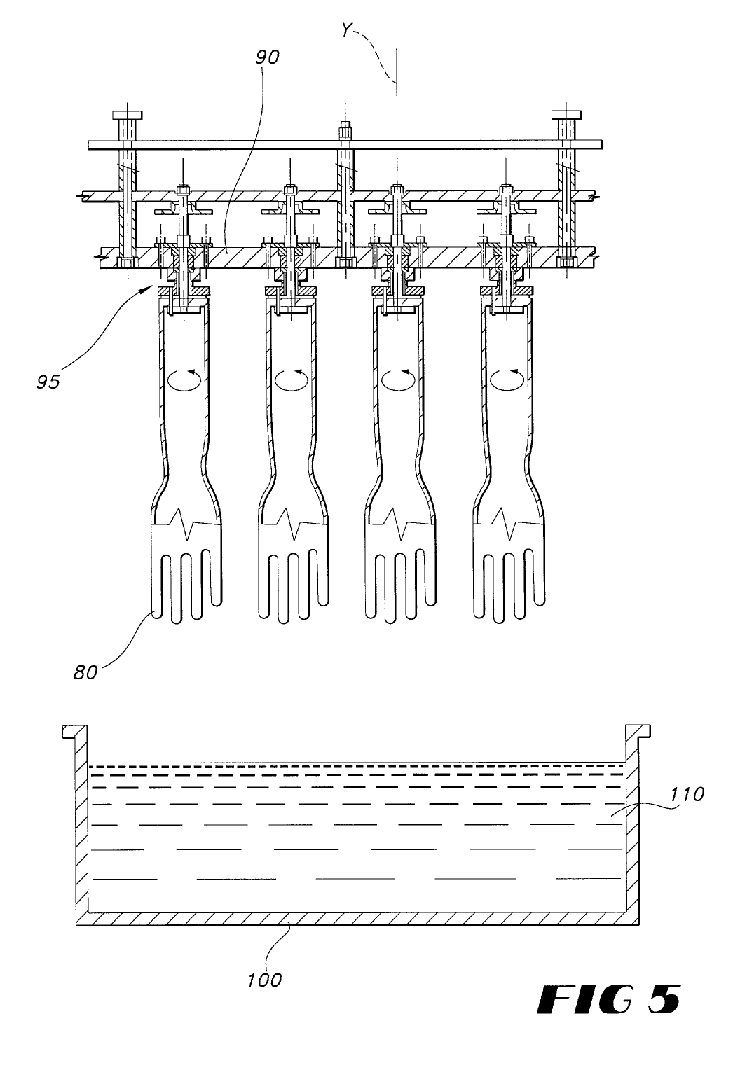

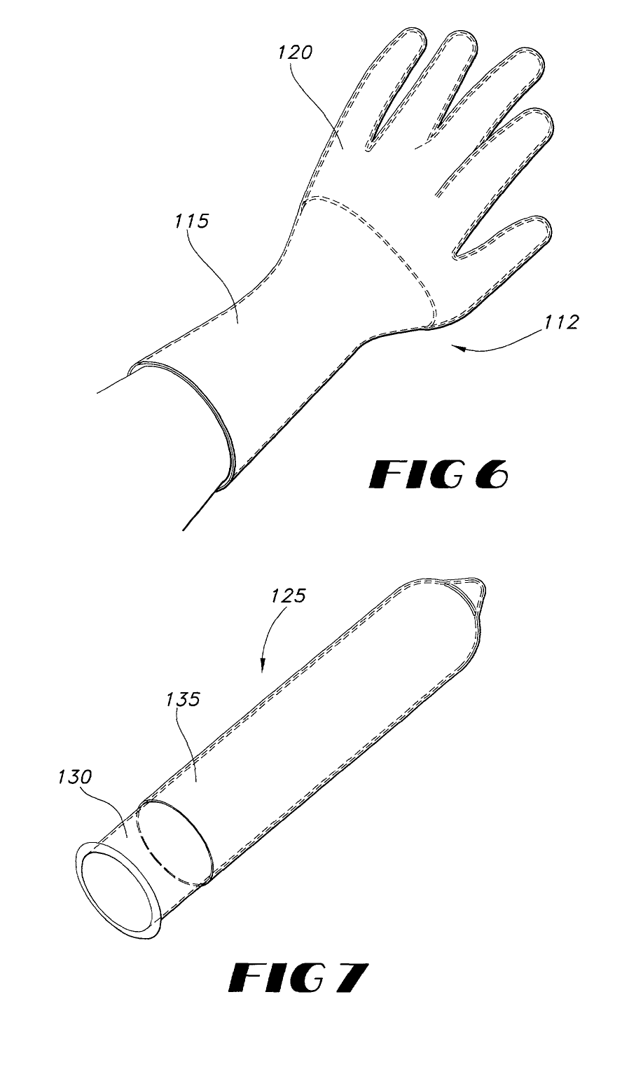

In the case of a glove, the second polymer layer, which is closer to the inside surface of the final product, may be used to cover an area of the glove which is particularly susceptible to rupture, or that is exposed to the highest degree of wear/physical abuse during use. Such a limited coverage layer is illustrated in FIGS. 2 through 4, and FIGS. 6 and 7, which shows a dipping progression of gloves and condoms through the described process, and final multicolored-multilayered articles. In particular, in FIG. 6, a multicolored glove is shown, with a second polymeric layer shown at 120, overlapping and adjacent the first polymeric base layer 115. A third clear layer is shown over the second coating layer. In FIG. 7, a multicolored condom 125 is shown, with a second polymeric layer shown at 135, overlapping and adjacent the first polymeric layer shown at 130. Referring again, to FIGS. 2-4, the first base polymer layer is shown as 50 in FIG. 2. The second colored protective layer is shown as 65 in FIG. 3. In the figure, the second colored layer is shown covering an area of the gloves encompassing all of the fingers and “knuckle” areas, but not including the entire palm or wrist area. Alternatively, the second coating layer may encompass the finger areas as well as the entire palm area of the glove. As previously stated, following dipping of the second layer (the coating layer), the former is withdrawn from a second dip tank and allowed to dry through either ambient conditions or ovens sufficient to dry the coating, form a film and assure good adhesion. It should be recognized that FIGS. 2-4 illustrate gloves on the former that are in fact, inside-out representations of gloves that are to be worn, while FIGS. 6 and 7 illustrate contrasts in/on the surface, that may in some circumstances be seen in a glove and condom from the outside of the article.

Following the drying of the second layer, one or more additional colored or clear polymeric layers may be added in the same fashion as the second layer. For instance, the former may be dipped into a third dip tank in an additional dip step 40 (as seen in FIG. 1) containing either a clear or translucent layer of polymeric material, such as polyurethane, or in the alternative, a second colored material, desirably of a color different from that of the second layer as in the glove layers 75 and 78 shown in FIGS. 4A and 4B. Examples of such second polymeric (coating) layers include urethane, acrylic or PVC emulsions. For instance, it may be desirable to dip the glove former into a third dip tank containing clear or translucent polyurethane. Such a layer may serve as a donning layer and may include other additives such as deglossing or texturizing agents. Desirably, the thickness of the third layer is between about 0.001 mm and 0.05 mm. Desirably, the thickness of the three-layered glove is between about 0.10 mm and 0.20 mm in the palm area.

Desirably such former is dipped to cover the entire former with the third layer up to the cuff level. The third layer then is allowed to dry in an additional dry step 45 (of FIG. 1), either at ambient conditions or in an oven. Such a third layer is illustrated in FIG. 4A as 75 on glove 70. In this fashion, a glove can be manufactured that visually signals a user that it includes multiple layers, imparting the knowledge that multiple layers of barrier protection are present on the glove. Furthermore, such a glove can be produced that is powderfree.

If an additional color is utilized in either a third or subsequent layers, such third or subsequent layers are in one embodiment, placed on the glove at positions that allow a user to see the various colored layers, such as at a position closer to the fingers and removed from the line of demarcation of the previous layer, as seen in FIG. 4B at 78. In an alternative embodiment, such colored layers overlap completely. Still in a further alternative embodiment, more than one additional colored layer is utilized on the glove and the glove additionally includes a clear or translucent final layer over the last colored layer.

In each of the embodiments, it is desirable that the visual contrast between layers be seen by a user. Such multicolored layers may in some circumstances be seen through the outer layer of the glove by a contrast in the glove shading, or by viewing the glove from the inside, prior to donning. Thus is especially true if the base polymer layer is translucent or clear to any extent. Such a glove offers a user the reassurance that multiple layers of protection stand between the user and various hostile or sensitive environments. The process can be ended at any stage once at least one colored layer has been added to the article along with a base polymer layer, in which a contrast between layers is visibly distinguishable by a user.

If the article being dipped is a glove, and after the determined amount of coated polymeric layers are added to the glove in the desired locations, a final polymeric layer, such as a donning layer, can be added to the glove via a final dipping step similar to those previously described. If such a final polymeric layer is not added, and the coating layer has not completely overlapped the base polymer layer, the remaining uncoated layer may have to be treated by chlorination or other post-processing step in order to assure that tackiness has been reduced and particles have been removed. If such a final polymeric layer is added, the former is then desirably dipped within the last polymeric solution, which itself may be colored or noncolored, and coated onto the other layers. The former is then removed from the solution and allowed to dry, again at either ambient conditions or in an oven. Examples of such donning layers are the same as mentioned earlier. Desirably, in one embodiment such final layer (second coating layer) is either clear or translucent.

Once the body of the glove or other article is formed, such as described above, a bead roll station (not shown) can, in some instances, be utilized to impart a cuff to the upper edge of the glove. As a further alternative, if the glove is not to be powder free, the addition of a slurry dip layer to the glove body may be added to prevent the gloves from sticking to each other once removed from the formers and during subsequent processing steps. Such a slurry may include calcium carbonate particles. Once dried, the formers may then be transferred to a stripping station (not shown) which can involve automatic or manual removal of the gloves from the formers. For example, the gloves, in one embodiment, are manually removed from each former by being turned inside out as they are stripped from the corresponding former. After being stripped, the gloves can then be chlorinated, if desired, using any known chlorination technique, such as that described in U.S. Pat. No. 5,792,531 to Littleton, et all, incorporated by reference herein in its entirety.

The invention is further described in the following examples. It should be understood that the examples are meant only to be illustrative and are not meant to be limiting in any way either the spirit or scope of the claimed invention.

Examples 1-9 which follow utilized water-based green pigment in a polyurethane layer (PU). The green pigment was obtained from Sun Chemical under the designation Flexiverse Green, GFD-1151, WB 7410 at 50.1% solids, Phthalocyanine green, BS. The polyurethane was comprised of Chang Yang (CY) CP-815 available from Chang Yang Stabilizer Co, of Taiwan, R.O.C. at 1% solids in the dip coating. Several trials were made using the formulas and methods expressed in Table 1. For the purposes of the Table, “phr” shall mean parts per hundred of the rubber polymer. Also for the purposes of Table 1, the abbreviation “PVC” shall refer to flexible polyvinyl chloride. The polyvinyl chloride resin is available from Occidental Chemical Corporation of Dallas, Tex. For the purposes of the examples, the flexible PVC contained the following materials:

1) 100 parts PVC resin which consisted of high molecular weight PVC, grade 80HC.

2) 100 parts of a plasticizer. While Diisononyl phthalate (DINP), from Exxon, was utilized, it would be appropriate to also utilize other plasticizers or blends, such as DIDP and DOA.

3) 5 parts of a heat stabilizer of the calcium/zinc type such as Akros, grade Interstab-CZL-717.

4) 5 parts of epoxidized soybean oil (ESO) from Akros, specifically Plastoflex 2307

5) Between 0-10 parts of a viscosity adjustment agent, such as an aliphatic hydrocarbon, exemplified by Exxon, grade Jayflex 215, and;

6) Between 0-2 parts Pigments as described herein.

It should be noted that the plasticizer is first added to a mixing tank and then, the PVC resin is added using a high shear mixer. The other components are then added.

The abbreviation “BFG” shall refer to B.F. Goodrich. The term “½ dip” shall refer to a hand dipped article that is dipped to approximately half its length. In the case of a glove, the term refers to an area approximately where the palm meets the wrist on the former up to a line of about 1 inch below the thumb crotch. The term “Full dip” refers to a hand-dipped article that is dipped to an area approximately at the article's length, such as the cuff area in the case of a glove, up to the bead.

TABLE 1

| BASE POLYMER | FIRST LAYER | SECOND LAYER |
|---|---|---|
| Clear PVC | ½ dip green CY PU | Full dip clear CY PU |
| Clear PVC | Full dip clear CY PU | ½ dip green CY PU |
| Clear PVC | ½ dip green CY PU | Full dip green CY PU |
| Clear PVC | Full dip green CY PU | ½ dip green CY PU |
| 1 phr white PVC | Full dip green CY PU | ½ dip green CY PU |
| 1 phr white PVC + | Full dip green CY PU | ½ dip green CY PU |
| 0.1 green PVC | | |
| 1 phr white PVC + | Full clear CY PU | ½ dip green CY PU |
| 0.1 green PVC | | |
| 0.2 phr white PVC | Full dip CY PU (clear) | ½ dip 0.05% green CY PU |
| 0.25 phr white | Full dip clear CY PU | ½ full green CY PU |
| PVC + 0.1 | | |
| green PVC | | |
| 0.5 phr white | Full dip clear BFG PU | ½ green BFG PU |
| PVC + 0.1 | | |
| phr green PVC | | |
| 0.5 phr white | Full dip clear BFG PU | ½ green BFG PU |
| PVC + 0.2 | | |
| phr green PVC | | |
| 0.5 phr white | Full dip CY PU | ½ dip 0.3% green CY PU |
| PVC + 0.1 | | |
| phr green PVC | | |

The green pigments were added to the polyurethane to make between 0.02-0.4% green solution. Additionally, polyvinyl chloride plastisol base polymer (PVC) with either white, white and green, or no color were used. The white pigment was Harwick Chemical Stan-Tone HCC-12146. The gloves were hand dipped in the lab using methods known to those in the art using ceramic formers. The dipped formers were held in the dip solution for approximately 2 to 3 seconds after complete immersion and then removed. The coated formers were allowed to dry in an oven (forced air Despatch Model LFD) heated at 225° C., for between 1-2 minutes. It should also be noted that green polyurethane was also made using BFGoodrich Hyslip 20022 (now Noveon) and green pigment as above. Hyslip 20022 contains 1-methyl-2-pyrrolidone and waterborne polyurethane.

Additionally, the following examples were run to test the efficacy of the process and glove produced therefrom. As in the previous examples a green polyurethane coating was placed on a PVC base polymer to form a glove. The process for producing the glove was the same as in the previous examples. In this set of examples, however, the polyurethane solution was made with BFG Hyslip 20022 with 1.4% solids and 0.25% Surfynol TG. The formulation included a wetting agent exemplified by the Surfynol TG, available from Air Products Chemicals. For this set of examples, the water-based white pigment was 50% TiO₂suspension. The water-based green pigment was Sun Chemical GFD-1151 WB 7410 50% solids.

A PVC condom was then made using a phallic shaped former and the same dipping process as previously described. The former was then dipped into the 0.5% white/0.1% green PU and coated.

In a second trial, a 0.5% white, 0.06% green PU solution was made. As in the previous example, a PVC condom was first made. The former was then dipped into the colored PU. The dipping process and drying conditions were the same as in the prior examples.

In this fashion the final coating on the colored article can be used to render the article powder-free, with improved donnability. The method also allows for thinner layers of low-solids, water-based layers to be easily added compared to the base layer of polymer. The user of the glove or other film-based article can visually observe the multiple layers of the article, as an indicator of the increased level of barrier protection. By introducing a variety of colors into the coating layers of a film based article, as opposed to the base polymer layer, the process is easily controllable, manufacturing friendly and reduces flow marks, as it allows for the addition of color contrast via coatings, which are much easier to change out (i.e. quick change over time), than adding color to the base polymer. Finally, the extra layers on the gloves will reduce the possibility of pinholes and improve out-of-the box barrier protection.

While the invention has been described in detail with respect to the specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and any equivalents thereto.

What is claimed is:

1. A method of making a colored, multi-layered polymer coated article comprising the steps of:
a) providing a former in the shape of an article;
b) dipping said former in a first polymeric solution in order to coat the former with a first coating of a base polymeric film of said first polymeric solution;
c) withdrawing said former from said first polymeric solution and allowing said coated former to dry;
d) dipping said former in a second polymeric solution in order to coat said previously coated former with a second coating, wherein said second polymeric solution produces a second coating of observable contrast to said first coating;
e) withdrawing said former from said second polymeric solution and allowing said second coating to dry, thereby forming an article on said former;
f) stripping said article from said former.

2. The method of claim 1 wherein following step e, and prior to step f, said former is dipped in a third polymeric solution in order to coat said former a third time, and then withdrawn from said third polymeric solution and allowed to dry.

3. The method of claim 1 wherein the former is first coated with a coagulant or stripping agent prior to being dipped in a first polymeric solution.

4. The method of claim 2 wherein said third polymeric solution is either a clear or translucent solution.

5. The method of claim 1 wherein said second polymeric solution coats less of the former than the first polymeric solution.

6. The method of claim 2, wherein said third polymeric solution is in contrast with said second polymeric solution.

7. The method of claim 6 wherein said third polymeric solution coats less of the former than the second polymeric solution.

8. The method of claim 7 further including a step of dipping said former in a clear polymeric solution and allowing said former to dry prior to stripping the article form the former.

9. A glove produced by the method of claim 1.

10. A condom produced by the method of claim 1.

11. An article produced by the method of claim 1.

12. A glove produced by the method of claim 2.

13. A condom produced by the method of claim 2.

14. An article produced by the method of claim 2.

15. A colored polymer coated film-based article comprising:
a first layer of a polymeric film material;
a second layer of polymeric film material formed on top of said first layer, said second layer in contrast from said first layer.

16. The colored polymer coated film-based article of claim 1 comprising a third polymeric film layer formed on top of said second layer.

17. The colored polymer coated film-based article of claim 16, wherein said third layer comprises either a clear or translucent polymeric film layer.

18. The polymer coated film-based article of claim 15, wherein said article is either a glove, condom, or a catheter balloon.

19. The colored polymer coated film-based article of claim 16, wherein said third polymeric film layer is in contrast to said second layer.

20. The colored polymer coated film-based article of claim 19, further including a fourth film-based layer formed on top of said third polymeric layer, wherein said fourth film-based layer is either clear or translucent.

21. A colored polymer coated film-based article comprising:
a first layer of a polymeric film material; wherein said first polymeric film material includes polyvinylchloride,
a second layer of polymeric film material formed on top of said first layer, wherein said second layer of polymeric film material includes a polyurethane, said second layer in visual contrast from said first layer.

22. The colored polymer coated film-based article of claim 21 further including a third clear or translucent polymeric layer over said second layer, wherein said article is powderfree.

23. The colored polymer coated film-based article of claim 21 wherein said second layer of polymeric film material is colored.

24. The colored polymer coated film-based article of claim 21 wherein said second layer of polymeric film material coats less of the article than said first layer.
